(19) United States
(12) Patent Application Publication
(10) Pub. No.: US 2025/0363895 A1
(43) Pub. Date: Nov. 27, 2025

(54) TAXIWAY NAVIGATION SYSTEM FOR ENHANCED PILOT HEADS-UP OPERATION

(71) Applicant: Rockwell Collins, Inc., Cedar Rapids, IA (US)

(72) Inventors: Suganthi Johnson, Cedar Rapids, IA (US); Gregory Crawford, Marion, IA (US); Callahan Johnson, Cedar Rapids, IA (US); Nicholas Helsper, Anamosa, IA (US); Vinay Gidla, Cedar Rapids, IA (US); Satyanarayana Kondiboyina, Cedar Rapids, IA (US); Justin Amble, Marion, IA (US); Caleb Groff, Cedar Rapids, IA (US); David Leedom, Center Point, IA (US); David Young, Garden Ridge, TX (US)

(21) Appl. No.: 19/210,586

(22) Filed: May 16, 2025

(30) Foreign Application Priority Data
May 24, 2024 (IN) 202411040584

(51) Int. Cl. G08G 5/51; B64D 43/00; B64D 45/00; G01C 23/00

(52) U.S. Cl. CPC G08G 5/51; B64D 43/00; B64D 45/00; G01C 23/005

(57) ABSTRACT

A system for taxiway navigation of an aircraft is disclosed. The system may include a display configured to display a graphical user interface (GUI) and a controller communicatively coupled to the display. The controller may include one or more processors configured to execute a set of program instructions stored in a memory. The program instructions may be configured to cause the processors to receive a current location of the aircraft, determine a route from the current location to a destination location, generate the GUI based on the route, and direct the display to display the GUI. The GUI may include a message bar, a next segment identifier, a dynamic distance indication, a direction arrow, and a current segment identifier.

### TECHNICAL FIELD

The present application claims the benefit of India Provisional Patent Application 202411040584, filed May 24, 2024, titled TAXIWAY NAVIGATION SYSTEM FOR ENHANCED PILOT HEADS-UP OPERATION, which is incorporated herein by reference in the entirety.

### TECHNICAL FIELD

The present disclosure relates generally to avionics systems, and, particularly, to systems and methods for taxiway navigation of an aircraft.

### BACKGROUND

Automotive navigation systems have long benefited from real-time, turn-by-turn navigation technologies that guide drivers through complex road systems.

Navigating through the intricate network of taxiways and runways at airports may be a critical task for pilots. A pilot's attention may need to be shared among many different tasks. Therefore, a pilot's available attention may be particularly valuable.

Therefore, there is a need for a system and method that can efficiently enhance the awareness and reliability of airport navigation.

### SUMMARY

A system configured for taxiway navigation of an aircraft is disclosed in accordance with one or more illustrative embodiments of the present disclosure. In one illustrative embodiment, the system may include a display configured to display a graphical user interface (GUI). In another illustrative embodiment, the system may include a controller communicatively coupled to the display. In another illustrative embodiment, the controller may include one or more processors configured to execute a set of program instructions stored in a memory. In another illustrative embodiment, the set of program instructions may be configured to cause the one or more processors to receive a current location of the aircraft, determine a route from the current location to a destination location based on at least the current location, generate the GUI based on the route, and direct the display to display the GUI. In another illustrative embodiment, the GUI may include a message bar configured to selectively display a textual description of at least one of a direction for the aircraft to follow, a warning of an upcoming condition, or an alert of a proximate situation. In another illustrative embodiment, the GUI may include a next segment identifier of a next segment of the route, a dynamic distance indication representing a distance from the current location to a next direction transition on the route, a direction arrow indicating a direction of the next direction transition, and a current segment identifier of a current segment on which the aircraft is located.

In a further aspect, the direction arrow may include a countable number of tick marks on a vertical portion of the direction arrow corresponding to a countable number of available direction transitions which are present before the next direction transition and which are in the same direction as the direction of the next direction transition. In another aspect, the message bar may be configured to display a textual description of the next direction transition on the route and the distance to the next direction transition. In another aspect, the message bar may be configured to display a textual warning indicating that the aircraft is approaching a predetermined hot spot on the route, and the direction arrow may be configured to change in color when the textual warning is displayed. In another aspect, the message bar may be configured to display a textual alert indicating that the aircraft is approaching a hold short position on the route. In another aspect, the GUI may further include a top-down graphical representation of an airport layout corresponding to the route. In another aspect, the next segment identifier and the current segment identifier each may include at least one of a taxiway identifier and a runway identifier. In another aspect, the display may be integrated into an aircraft cockpit instrument panel. In another aspect, the GUI may include a top-down view of the route, and an adjacent arrangement of components including the next segment identifier, the dynamic distance indication, the direction arrow, and the current segment identifier. In another aspect, each of the components may be adjacent to at least another of the components.

A method for taxiway navigation of an aircraft is disclosed in accordance with one or more illustrative embodiments of the present disclosure. In one illustrative embodiment, the method may include receiving a current location of an aircraft, determining a route from the current location to a destination location, generating a graphical user interface (GUI) based on the route, and displaying the GUI on a display. In another illustrative embodiment, the GUI may include a message bar, a next segment identifier, a dynamic distance indication, a direction arrow, and a current segment identifier.

In a further aspect, the direction arrow may include a countable number of tick marks on a vertical portion of the direction arrow corresponding to a countable number of available direction transitions which are present before the next direction transition and which are in the same direction as the direction of the next direction transition. In another aspect, the message bar may be configured to display a textual description of the next direction transition on the route and the distance to the next direction transition. In another aspect, the message bar may be configured to display a textual warning indicating that the aircraft is approaching a predetermined hot spot on the route, and the direction arrow may be configured to change in color when the textual warning is displayed. In another aspect, the message bar may be configured to display a textual alert indicating that the aircraft is approaching a hold short position on the route. In another aspect, the GUI may further include a top-down graphical representation of an airport layout corresponding to the route. In another aspect, the next segment identifier and the current segment identifier each may include at least one of a taxiway identifier and a runway identifier. In another aspect, the display may be integrated into an aircraft cockpit instrument panel. In another aspect, the GUI may include a top-down view of the route, and an adjacent arrangement of components including the next segment identifier, the dynamic distance indication, the direction arrow, and the current segment identifier. In another aspect, each of the components may be adjacent to at least another of the components.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A is a simplified block diagram of an aircraft including the system for taxiway navigation of an aircraft, in accordance with one or more embodiments of the present disclosure.

FIG. 1B is an aircraft including the system, in accordance with one or more embodiments of the present disclosure.

FIG. 2 is a flow diagram illustrating steps performed in a method for taxiway navigation of an aircraft, in accordance with one or more embodiments of the present disclosure.

FIG. 3 is an adjacent arrangement of components of a GUI for taxiway navigation of an aircraft, in accordance with one or more embodiments of the present disclosure.

FIG. 4 is an adjacent arrangement of components of a GUI for taxiway navigation of an aircraft including a textual warning indicating that the aircraft is approaching a predetermined hot spot, in accordance with one or more embodiments of the present disclosure.

FIG. 5 is a set of GUIs showing a variety of configurations, in accordance with one or more embodiments of the present disclosure.

FIG. 6 is a GUI showing a direction arrow including tick marks, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Broadly speaking, embodiments of the concepts disclosed herein are directed to a system and method for displaying taxiway navigation of an aircraft. The GUI may be displayed using a compact arrangement of graphical components incorporating a variety of symbolic visual cues and text-based information configured to quickly give a pilot relevant spatial awareness and reduce improper navigation (e.g., missed turns). In at least some embodiments, the GUI may utilize directional arrows with tick marks corresponding to a number of upcoming intersections or the like before the next turn should be made, thereby giving a fast and visually efficient visual indication of how far until the next turn. This may be faster for a user to mentally process than other indications. For example, only having a numerical indication (e.g., 1,324 ft until next turn) may take longer to mentally read and process than a number of tick marks on an arrow. The tick marks may abstract-out this navigational information in a more intuitive way (e.g., number of intersections or turns until a user should make a turn) than other indications of upcoming turns such as maps, text, or the like. In at least some embodiments, the particular arrangement of the graphical components may provide additional information in a compact arrangement that may also be relatively efficient to mentally process. For example, after looking at a direction arrow with tick marks, the user may quickly glance left to an indicator of the next runway or the like corresponding to the turn. This arrangement may be less confusing, more compact, and faster to understand than other arrangements.

By incorporating intuitive visual cues and critical information display, at least some embodiments herein may streamline taxiway navigation, reduce pilot workload, and contribute to overall aviation safety.

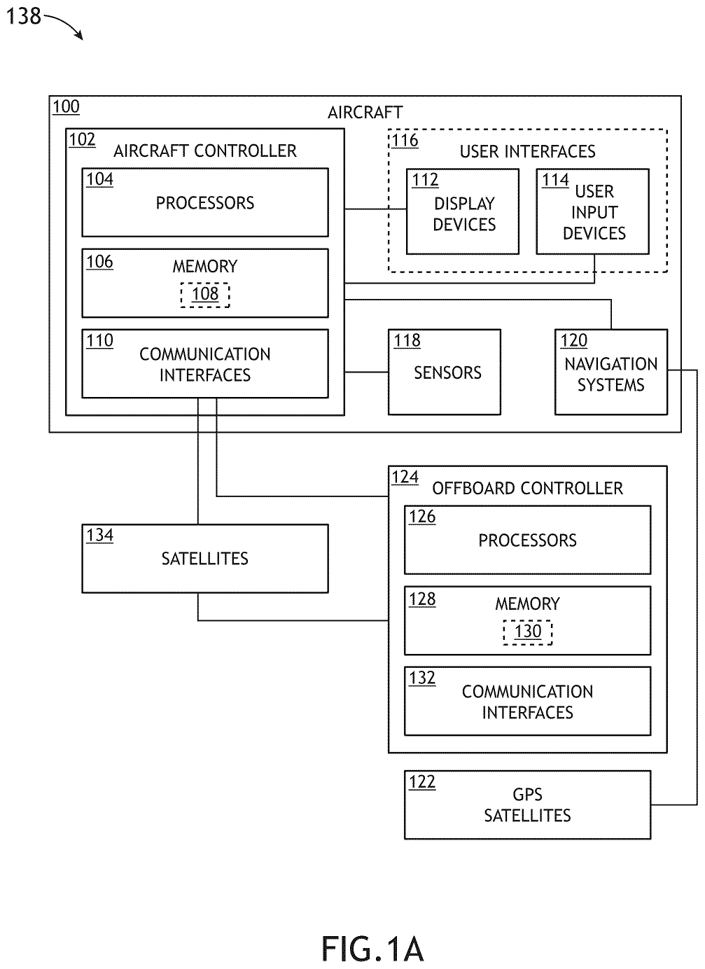

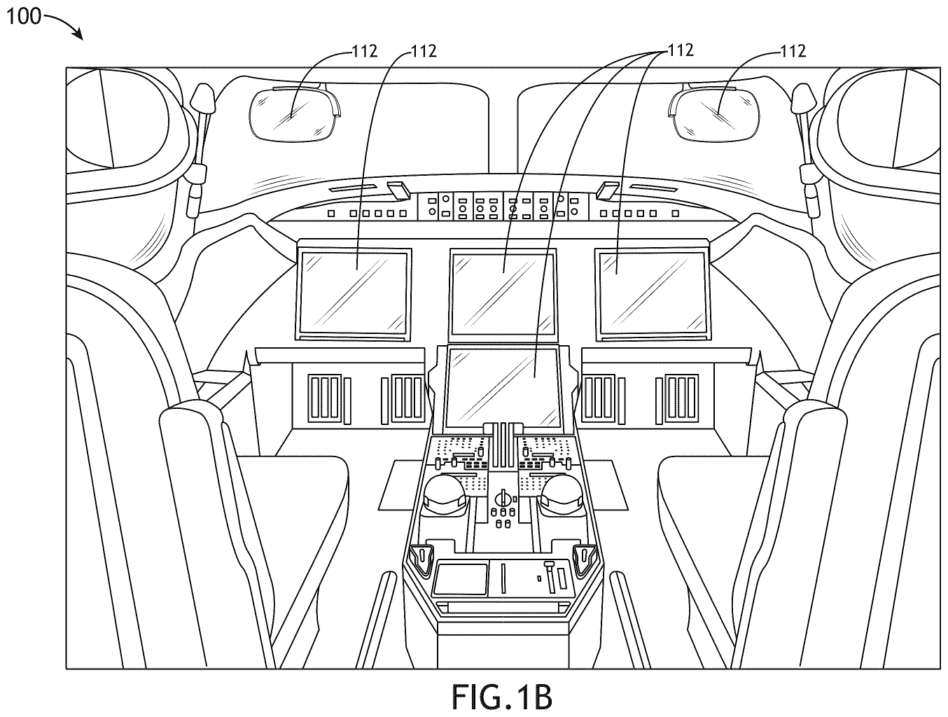

Referring now to FIGS. 1A-1B, an aircraft including a system 138 is illustrated, in accordance with one or more embodiments of the present disclosure.

Referring now to FIG. 1A, the aircraft 100 may include an aircraft controller 102 (e.g., on-board/run-time controller). The aircraft controller 102 may include one or more processors 104, memory 106 configured to store one or more program instructions 108, and/or one or more communication interfaces 110.

The aircraft 100 may include an avionics environment such as, but not limited to, a cockpit. The aircraft controller 102 may be coupled (e.g., physically, electrically, and/or communicatively) to one or more display devices 112. The one or more display devices 112 may be configured to display three-dimensional images and/or two-dimensional images. Referring now to FIG. 1B, the avionics environment (e.g., the cockpit) may include any number of display devices 112 (e.g., one, two, three, or more displays) such as, but not limited to, one or more head-down displays (HDDs) 112, one or more head-up displays (HUDs) 112, one or more multi-function displays (MFDs), one or more adaptive flight displays (AFDs) 112, one or more primary flight displays (PFDs) 112, or the like. The one or more display devices 112 may be employed to present flight data including, but not limited to, situational awareness data and/or flight queue data to a pilot or other crew member. For example, the situational awareness data may be based on, but is not limited to, aircraft performance parameters, aircraft performance parameter predictions, sensor readings, alerts, or the like.

Referring again to FIG. 1A, the aircraft controller 102 may be coupled (e.g., physically, electrically, and/or communicatively) to one or more user input devices 114. The one or more display devices 112 may be coupled to the one or more user input devices 114. For example, the one or more display devices 112 may be coupled to the one or more user input devices 114 by a transmission medium that may include wireline and/or wireless portions. The one or more display devices 112 may include and/or be configured to interact with one or more user input devices 114.

The one or more display devices 112 and the one or more user input devices 114 may be standalone components within the aircraft 100. It is noted herein, however, that the one or more display devices 112 and the one or more user input devices 114 may be integrated within one or more common user interfaces 116.

Where the one or more display devices 112 and the one or more user input devices 114 are housed within the one or more common user interfaces 116, the aircraft controller 102, one or more offboard controllers 124, and/or the one or more common user interfaces 116 may be standalone components. It is noted herein, however, that the aircraft controller 102, the one or more offboard controllers 124, and/or the one or more common user interfaces 116 may be integrated within one or more common housings or chassis.

The aircraft controller 102 may be coupled (e.g., physically, electrically, and/or communicatively) to and configured to receive data from one or more aircraft sensors 118. The one or more aircraft sensors 118 may be configured to sense a particular condition(s) external or internal to the aircraft 100 and/or within the aircraft 100. The one or more aircraft sensors 118 may be configured to output data associated with particular sensed condition(s) to one or more components/systems onboard the aircraft 100. Generally, the one or more aircraft sensors 118 may include, but are not limited to, one or more inertial measurement units, one or more airspeed sensors, one or more radio altimeters, one or more flight dynamic sensors (e.g., sensors configured to sense pitch, bank, roll, heading, and/or yaw), one or more weather radars, one or more air temperature sensors, one or more surveillance sensors, one or more air pressure sensors, one or more engine sensors, and/or one or more optical sensors (e.g., one or more cameras configured to acquire images in an electromagnetic spectrum range including, but not limited to, the visible light spectrum range, the infrared spectrum range, the ultraviolet spectrum range, or any other spectrum range known in the art).

The aircraft controller 102 may be coupled (e.g., physically, electrically, and/or communicatively) to and configured to receive data from one or more navigational systems 120. The one or more navigational systems 120 may be coupled (e.g., physically, electrically, and/or communicatively) to and in communication with one or more GPS satellites 122, which may provide vehicular location data (e.g., aircraft location data) to one or more components/systems of the aircraft 100. For example, the one or more navigational systems 120 may be implemented as a global navigation satellite system (GNSS) device, and the one or more GPS satellites 122 may be implemented as GNSS satellites. The one or more navigational systems 120 may include a GPS receiver and a processor. For example, the one or more navigational systems 120 may receive or calculate location data from a sufficient number (e.g., at least four) of GPS satellites 122 in view of the aircraft 100 such that a GPS solution may be calculated.

It is noted herein the one or more aircraft sensors 118 may operate as a navigation device 120, being configured to sense any of various flight conditions or aircraft conditions typically used by aircraft and output navigation data (e.g., aircraft location data, aircraft orientation data, aircraft direction data, aircraft speed data, and/or aircraft acceleration data). For example, the various flight conditions or aircraft conditions may include altitude, aircraft location (e.g., relative to the earth), aircraft orientation (e.g., relative to the earth), aircraft speed, aircraft acceleration, aircraft trajectory, aircraft pitch, aircraft bank, aircraft roll, aircraft yaw, aircraft heading, air temperature, and/or air pressure. By way of another example, the one or more aircraft sensors 118 may provide aircraft location data and aircraft orientation data, respectively, to the one or more processors 104, 126.

The aircraft controller 102 of the aircraft 100 may be coupled (e.g., physically, electrically, and/or communicatively) to one or more offboard controllers 124.

The one or more offboard controllers 124 may include one or more processors 126, memory 128 configured to store one or more programs instructions 130 and/or one or more communication interfaces 132.

The aircraft controller 102 and/or the one or more offboard controllers 124 may be coupled (e.g., physically, electrically, and/or communicatively) to one or more satellites 134. For example, the aircraft controller 102 and/or the one or more offboard controllers 124 may be coupled (e.g., physically, electrically, and/or communicatively) to one another via the one or more satellites 134. For instance, at least one component of the aircraft controller 102 may be configured to transmit data to and/or receive data from at least one component of the one or more offboard controllers 124, and vice versa. By way of another example, at least one component of the aircraft controller 102 may be configured to record event logs and may transmit the event logs to at least one component of the one or more offboard controllers 124, and vice versa. By way of another example, at least one component of the aircraft controller 102 may be configured to receive information and/or commands from the at least one component of the one or more offboard controllers 124, either in response to (or independent of) the transmitted event logs, and vice versa.

It is noted herein that the aircraft 100 and the components onboard the aircraft 100, the one or more offboard controllers 124, the one or more GPS satellites 122, and/or the one or more satellites 134 may be considered components of a system 138, for purposes of the present disclosure.

The one or more processors 104, 126 may include any one or more processing elements, micro-controllers, circuitry, field programmable gate array (FPGA) or other processing systems, and resident or external memory for storing data, executable code, and other information accessed or generated by the aircraft controller 102 and/or the one or more offboard controllers 124. In this sense, the one or more processors 104, 126 may include any microprocessor device configured to execute algorithms and/or program instructions. It is noted herein, however, that the one or more processors 104, 126 are not limited by the materials from which it is formed or the processing mechanisms employed therein and, as such, may be implemented via semiconductor(s) and/or transistors (e.g., using electronic integrated circuit (IC) components), and so forth. In general, the term “processor” may be broadly defined to encompass any device having one or more processing elements, which execute a set of program instructions from a non-transitory memory medium (e.g., the memory), where the set of program instructions is configured to cause the one or more processors to carry out any of one or more process steps.

The memory 106, 128 may include any storage medium known in the art suitable for storing the set of program instructions executable by the associated one or more processors. For example, the memory 106, 128 may include a non-transitory memory medium. For instance, the memory 106, 128 may include, but is not limited to, a read-only memory (ROM), a random access memory (RAM), a magnetic or optical memory device (e.g., disk), a magnetic tape, a solid state drive, flash memory (e.g., a secure digital (SD) memory card, a mini-SD memory card, and/or a micro-SD memory card), universal serial bus (USB) memory devices, and the like. The memory 106, 128 may be configured to provide display information to the display device (e.g., the one or more display devices 112). In addition, the memory 106, 128 may be configured to store user input information from a user input device of a user interface. The memory 106, 128 may be housed in a common controller housing with the one or more processors. The memory 106, 128 may, alternatively or in addition, be located remotely with respect to the spatial location of the processors and/or a controller. For instance, the one or more processors and/or the controller may access a remote memory (e.g., server), accessible through a network (e.g., internet, intranet, and the like).

The aircraft controller 102 and/or the one or more offboard controllers 124 may be configured to perform one or more process steps, as defined by the one or more sets of program instructions 108, 130. The one or more process steps may be performed iteratively, concurrently, and/or sequentially. The one or more sets of program instructions 108, 130 may be configured to operate via a control algorithm, a neural network (e.g., with states represented as nodes and hidden nodes and transitioning between them until an output is reached via branch metrics), a kernel-based classification method, a Support Vector Machine (SVM) approach, canonical-correlation analysis (CCA), factor analysis, flexible discriminant analysis (FDA), principal component analysis (PCA), multidimensional scaling (MDS), principal component regression (PCR), projection pursuit, data mining, prediction-making, exploratory data analysis, supervised learning analysis, Boolean logic (e.g., resulting in an output of a complete truth or complete false value), fuzzy logic (e.g., resulting in an output of one or more partial truth values instead of a complete truth or complete false value), or the like. For example, in the case of a control algorithm, the one or more sets of program instructions 108, 130 may be configured to operate via proportional control, feedback control, feedforward control, integral control, proportional-derivative (PD) control, proportional-integral (PI) control, proportional-integral-derivative (PID) control, or the like.

The one or more communication interfaces 110, 132 may be operatively configured to communicate with one or more components of the aircraft controller 102 and/or the one or more offboard controllers 124. For example, the one or more communication interfaces 110, 132 may also be coupled (e.g., physically, electrically, and/or communicatively) with the one or more processors 104, 126 to facilitate data transfer between components of the one or more components of the aircraft controller 102 and/or the one or more offboard controllers 124 and the one or more processors 104, 126. For instance, the one or more communication interfaces 110, 132 may be configured to retrieve data from the one or more processors 104, 126, or other devices, transmit data for storage in the memory 106, 128, retrieve data from storage in the memory 106, 128, or the like. By way of another example, the aircraft controller 102 and/or the one or more offboard controllers 124 may be configured to receive and/or acquire data or information from other systems or tools by a transmission medium that may include wireline and/or wireless portions. By way of another example, the aircraft controller 102 and/or the one or more offboard controllers 124 may be configured to transmit data or information (e.g., the output of one or more procedures of the inventive concepts disclosed herein) to one or more systems or tools by a transmission medium that may include wireline and/or wireless portions (e.g., a transmitter, receiver, transceiver, physical connection interface, or any combination). In this regard, the transmission medium may serve as a data link between the aircraft controller 102 and/or the one or more offboard controllers 124 and the other subsystems (e.g., of the aircraft 100 and/or the system 138). In addition, the aircraft controller 102 and/or the one or more offboard controllers 124 may be configured to send data to external systems via a transmission medium (e.g., network connection).

The one or more display devices 112 may include any display device known in the art. For example, the display devices 112 may include, but are not limited to, one or more head-down displays (HDDs), one or more HUDs, one or more multi-function displays (MFDs), or the like. For instance, the display devices 112 may include, but are not limited to, a liquid crystal display (LCD), a light-emitting diode (LED) based display, an organic light-emitting diode (OLED) based display, an electroluminescent display (ELD), an electronic paper (E-ink) display, a plasma display panel (PDP), a display light processing (DLP) display, or the like. Those skilled in the art should recognize that a variety of display devices may be suitable for implementation in the present invention and the particular choice of display device may depend on a variety of factors, including, but not limited to, form factor, cost, and the like. In a general sense, any display device capable of integration with the user input device (e.g., touchscreen, bezel mounted interface, keyboard, mouse, trackpad, and the like) is suitable for implementation in the present invention.

The one or more user input devices 114 may include any user input device known in the art. For example, the user input device 114 may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device, or the like. In the case of a touchscreen interface, those skilled in the art should recognize that a large number of touchscreen interfaces may be suitable for implementation in the present invention. For instance, the display device may be integrated with a touchscreen interface, such as, but not limited to, a capacitive touchscreen, a resistive touchscreen, a surface acoustic based touchscreen, an infrared based touchscreen, or the like. In a general sense, any touchscreen interface capable of integration with the display portion of a display device is suitable for implementation in the present disclosure. In another embodiment, the user input device may include, but is not limited to, a bezel mounted interface.

In embodiments, the GUI 500 may be displayed on any computing device including a touchscreen (i.e., a touch-sensitive display surface capable of accepting directed control input provided by a user by making contact with a particular location relative to the display surface, e.g., by tapping, pressing for an extended length of time, or directing a finger or stylus along the surface of the screen in a predetermined path) and in communication with networks or controller devices/systems aboard the aircraft. For example, the GUI 500 may be displayed on a display 112 within a cockpit of the aircraft 100 as shown in FIG. 1B.

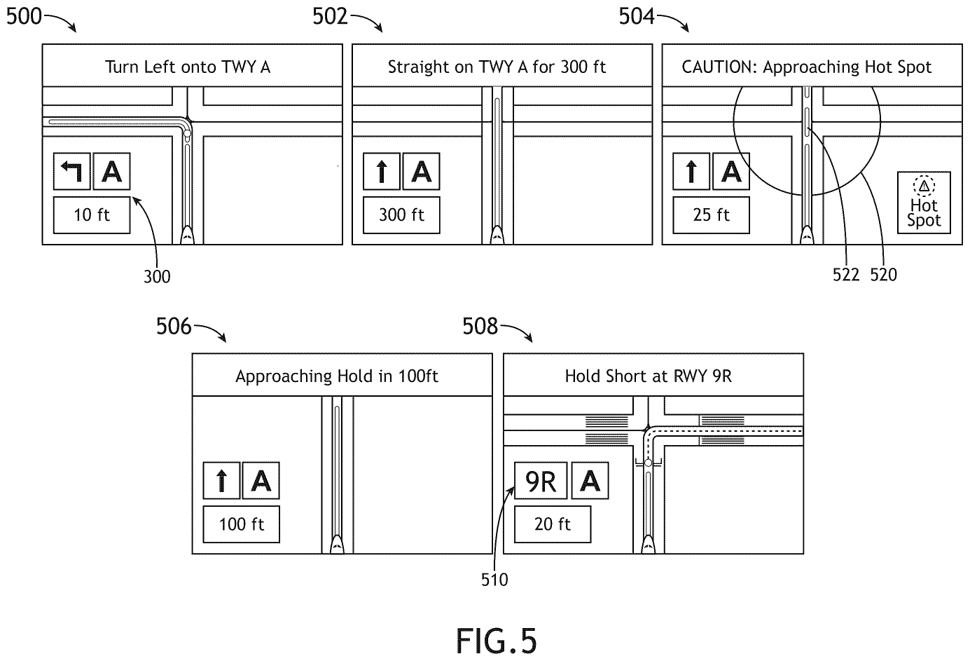

The system 138 may be configured for taxiway navigation of an aircraft 100. The system 138 may include a display 112. The system 138 may include a controller 102 (e.g., aircraft controller on the aircraft 100) communicatively coupled to the display 112 and configured to direct a display of the GUI (e.g., see FIG. 5 for an example of a GUI 500). For example, the controller 102 may direct a transmission configured to instruct the display 112 to display a set of pixels of a visual representation of the GUI 500.

The controller 102 may include one or more processors 104 configured to execute a set of program instructions 108 stored in a memory 106. The set of program instructions 108 may be configured to cause the one or more processors 104 to receive a current location of the aircraft 100, determine (or receive) a route from the current location to a destination location based on at least the current location, generate, based on the route, the GUI 500, and direction the display 112 to display the GUI.

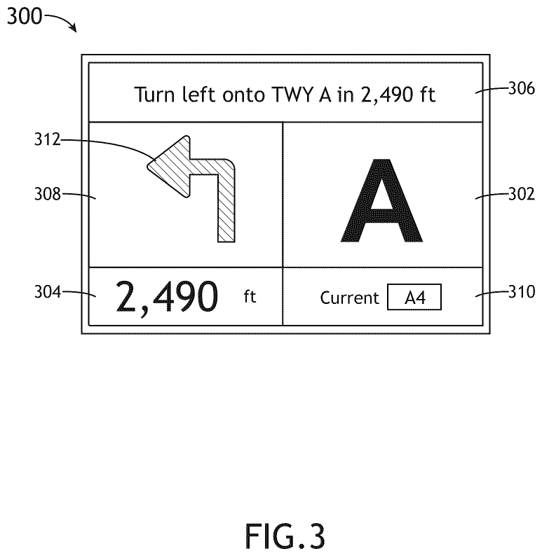

FIG. 3 illustrates an adjacent arrangement 300 of components of a GUI 500 for taxiway navigation of an aircraft 100, in accordance with one or more embodiments of the present disclosure.

The GUI 500 may include a dynamic distance indication 304 representing a distance from the current location to a next direction transition (e.g., next right-hand turn) on the route based on the route. For instance, the next direction transition may be a turn that is planned in the future based on the route.

The dynamic distance indication 304 may include a textual dynamic readout of a remaining distance to the next turn (e.g., next direction transition) in units such as, but not limited to, feet, yards, meters, or the like. The dynamic distance indication 304 may be relatively easily visible, ensuring accurate and timely information during taxi. The dynamic distance indication 304 may be configured to be updated on a periodic basis or the like. For example, as (updated) current locations (e.g., GPS coordinates) are received over time, (updated) remaining distances may be determined and used to update the dynamic distance indication 304. For instance, the dynamic distance indication 304 may be updated from 2,490 ft to 2,180 ft after the updated remaining distance is determined.

The GUI 500 may include a direction arrow area 308 that includes a direction arrow 312 indicating a direction of the next direction transition based on the next direction transition. For instance, for a left-hand turn, a 90-degree left arrow may be configured to be displayed. For instance, for a right-hand turn, a 90-degree right arrow may be configured to be displayed.

The GUI 500 may include a next segment identifier 302 (e.g., segment of a runway) of a next segment of the route. For instance, the next segment identifier 302 may include (or be) a Taxiway/Runway Identifier. The next segment identifier 302 may indicate the next taxiway or runway that the pilot will turn onto, enhancing pre-turn awareness.

The GUI 500 may include a current segment identifier 310 of the current segment on which the aircraft is located based on the current location. For example, as shown, the next segment identifier 302 and the current segment identifier 310 may each include at least one of a taxiway identifier and a runway identifier. In this regard, the current segment identifier 310 may inform pilots of the current taxiway, facilitating communication with Air Traffic Control (ATC), and maintaining situational awareness.

The GUI 500 may include a message bar 306 configured to selectively display a textual description of at least one of a direction for the aircraft to follow, a warning of an upcoming condition, or an alert of a proximate situation. The message bar 306 may include directions, warnings, and alerts, such as “Turn right in 350 ft,” “CAUTION: Approaching Hot Spot,” “Approaching Hold Short in 100 ft”. “A direction for the aircraft to follow” may encompass navigational instructions guiding the aircraft's movement or course while taxiing on the ground. Examples may include “Turn left at the next intersection”, “Follow taxiway Alpha”, or “Hold short of runway 27”. “A warning of an upcoming condition” may refer to advisories about potential hazards or situations requiring heightened awareness during ground operations. This may involve notifications such as “Caution: Construction area ahead”, “Warning: Low visibility conditions”, or “Expect delay at intersection”. “An alert of a proximate situation” may pertain to imminent circumstances or events in close proximity that demand immediate attention while the aircraft is on the ground. Examples may include “Traffic alert: Vehicle approaching from the left” or the like.

The message bar 306 may be configured to display a textual description of the next direction transition on the route and the distance to the next direction transition.

The message bar 306 may be configured to display a textual warning 316 indicating that the aircraft 100 is approaching a predetermined hot spot 522 on the route. The direction arrow 312 may be configured to change in color when the textual warning 316 is displayed. For example, the direction arrow 312 may be configured to change to orange. The predetermined hot spot 522 may be received from another controller wirelessly. The predetermined hot spot 522 may be indicated on the GUI 500 as shown in GUI 504, such as using a different color along the route. For example, the predetermined hot spot 522 may be orange or red and the route (e.g., route path) may be blue or green. The predetermined hot spot 522 may be surrounded by a larger warning graphic 520. The larger warning graphic 520 may be a circle shape, such as an orange circle. The hot spot may be an indication of a spot of higher risk, danger, or the like.

The message bar 306 may be configured to display a textual alert indicating that the aircraft is approaching a hold short position on the route.

The GUI 500 may include an adjacent arrangement of components 300 comprising: the next segment identifier 302, the dynamic distance indication 304, the direction arrow 312, and the current segment identifier 310. Each of these components 300 may be adjacent to at least another of the components 300. The message bar 306 may be included in the adjacent arrangement of components 300. In another embodiment, the message bar 306 is separate (e.g., spaced away) from the adjacent arrangement of components 300, such as being at the top of the GUI 500 while the adjacent arrangement of components 300 may be at the bottom of the GUI 500. For instance, the adjacent arrangement of components 300 may be in a bottom left corner of the GUI 500.

For example, the arrangement 300 may include any arrangement shown. For instance, as shown in FIG. 3, the adjacent arrangement of components 300 may include: the dynamic distance indication 304 in a bottom left corner of the adjacent arrangement 300, the current segment identifier 310 in a bottom right corner, the next segment identifier 302 above the current segment identifier 310, and the direction arrow 312 above the dynamic distance indication 304. For instance, such components may be in a (compact) two-by-two arrangement of rows and columns. Such an arrangement may provide an advantage of efficient use of footprint of the GUI.

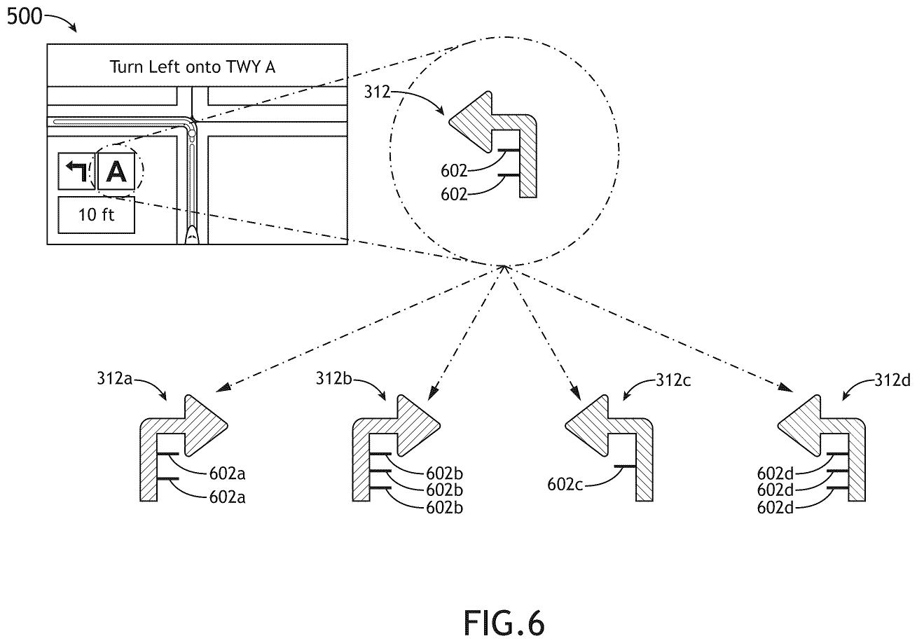

FIG. 6 illustrates a GUI 500 showing a direction arrow 312 including tick marks 602, in accordance with one or more embodiments of the present disclosure. This may improve a pilot's spatial awareness and reduce the likelihood of a missed turn by providing a fast visualization of the number of remaining turns (e.g., intersections) in the same direction to pass before a turn of the aircraft 100 should be executed.

The direction arrow 312 may include a countable number of tick marks 602 on a vertical portion of the direction arrow 312. The tick marks 602 may correspond to a countable number of available direction transitions which are present before the next direction transition and which are in the same direction as the direction of the next direction transition. For example, as shown by direction arrow 312a, if the third upcoming right turn is the next direction transition (e.g., next right turn), then the direction arrow 312a may include two tick marks 602a as shown. Examples for tick marks 602b, 602c, and 602d are shown when the upcoming next direction transition is a fourth upcoming right turn, second upcoming left turn, and fourth upcoming left turn, respectively.

The countable number of tick marks 602 may correspond to the direction. For example, the countable number of tick marks 602 may be on the left side of the vertical portion for left hand turn direction arrows 312c, 312d as shown by tick marks 602c, 602d. The countable number of tick marks 602 may be on the right side of the vertical portion for left hand turn direction arrows 312a, 312b as shown by tick marks 602a, 602b.

The countable number of tick marks may change (e.g., reduce) as the current location changes over time. For example, as the aircraft 100 passes a right turn, then a direction arrow 312b with three tick marks 602b may become (or be changed or altered or swapped to be) a direction arrow 312a with two tick marks 602a. A countable number of available turns in an opposite direction (e.g., left) to a right direction turn may be irrelevant or not necessarily shown.

For purposes of the present disclosure, directions may be abstracted as left or right, where any available direction transition on the right side is a right direction and any on the left side is a left direction. For example, a standard 90-degree right turn, a 95-degree right turn, and even a 135 degree to the right may all be considered a turn in the same (right) direction.

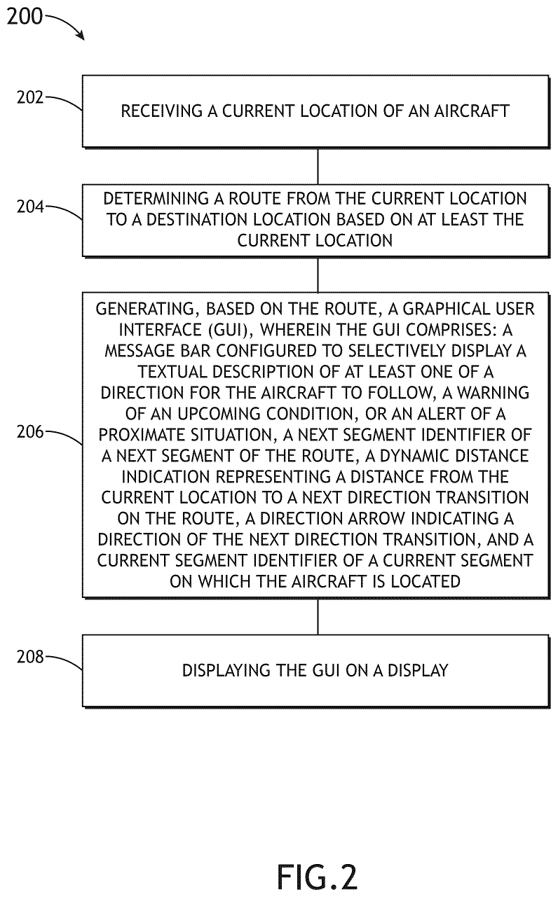

FIG. 2 illustrates a process flow diagram depicting a method 200 for taxiway navigation of an aircraft, in accordance with one or more embodiments of the present disclosure. It is noted that the embodiments and enabling technologies described previously herein in the context of the system 138 should be interpreted to extend to the method 200. It is further noted herein that the steps of method 200 may be implemented all or in part by system 138. It is further recognized, however, that the method 200 is not limited to the system 138 in that additional or alternative system-level embodiments may carry out all or part of the steps of method 200.

At step 202, a current location of an aircraft 100 is received. For example, the current location may be received by relative positioning using sensors (e.g., cameras, radar) or shared between controllers and applications (e.g., a function, application, module of an application, and/or the like may update other applications), received by the aircraft's own navigation sub-system (e.g., GPS system), and/or the like. For example, the current location may be in any format, such as longitudinal and latitude coordinates, or relative coordinates to a map or beacon of an airport. For instance, the current location may be GPS coordinates received using an aircraft GPS. For instance, the current location may be detected by a third-party sensor such as a radar sensor of an airport.

At step 204, a route is determined from the current location to a destination location based on at least the current location. For example, the route may be determined by a controller based on the current location. For instance, path finding code may determine the shortest route or the like between the current location of the aircraft 100 and the destination. For instance, any navigational software may be used. For instance, the route may be known (e.g., received by a different controller) and used to generate the GUI 500. For instance, the route may be determined from scratch, using a map and path finding algorithms and/or the like. For instance, the route may be simply received, such as being determined by a third-party (e.g., central airport control authority) and wirelessly communicated to the aircraft 100.

At step 206, a graphical user interface (GUI) (e.g., see an example GUI as shown by GUI 500 of FIG. 5) is generated based on the route. For example, any embodiments and/or the like of the present disclosure may be generated by one or more controllers, such as via controller 102.

At step 208, the GUI is displayed on the display 112. For example, the display 112 may display the GUI 500 to a user.

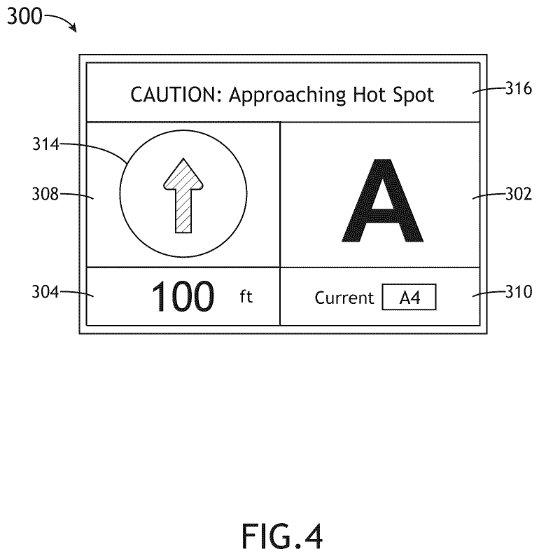

FIG. 4 illustrates an adjacent arrangement 300 of components including a textual warning 316 indicating that the aircraft is approaching a predetermined hot spot 522, in accordance with one or more embodiments of the present disclosure.

The direction area location of the GUI 500 may show a hot spot version of an arrow 314 with changed colors when the textual warning 316 is displayed.

FIG. 5 illustrates a set of GUIs 500, 502, 504, 506, 508 showing a variety of configurations, in accordance with one or more embodiments of the present disclosure.

For example, the GUI 500 may further include a top-down graphical representation of an airport layout including the route as shown by GUIs 500, 502, 504, 506, 508.

The GUI 500 may include a top-down view of the route as shown in FIG. 5. For example, the top-down view may be configured to provide turn-by-turn navigation of an airport, for ground-based navigation. The adjacent arrangement of components 300 may be overlaid on top of the top-down view of the route, such as.

The display 112 including the GUI 500 may be integrated into an aircraft cockpit instrument panel 112, such as, but not necessarily limited to, any of the displays 112 shown in FIG. 1B.

As shown in GUI 508, the direction arrow 312 may be configured to be replaced by a runway indicator 510 (e.g., text “9R” for runway 9R) when the aircraft 100 is within a threshold distance of a particular runway (e.g., destination runway). For example, the threshold distance may be any distance, such as at or within 20 feet of the runway. This may be to alert the pilot and provide more emphasis than an arrow. For example, the text or background of the runway indicator 510 may be in a different color than surrounding colors such as being the color red.

Embodiments herein may provide alternative systems and methods for providing feedback to pilots when interacting with touch display widgets to activate specific functionalities. Embodiments may serve as a mechanism to prevent unintended activation of features by requiring a pilot to engage with the display for a specified duration, thereby confirming the intended operation. Further, combinations of other feedback mechanisms may improve the pilot's understanding of the timing of the functions, such as increasing haptic feedback frequencies and intensity, changing colors over time, and numerical representations. The combination may provide surety of feedback not necessarily achievable by a single feedback mechanism alone.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A system configured for taxiway navigation of an aircraft, the system comprising:
a display configured to display a graphical user interface (GUI); and
a controller communicatively coupled to the display, wherein the controller comprises one or more processors configured to execute a set of program instructions stored in a memory, the set of program instructions configured to cause the one or more processors to:
receive a current location of the aircraft;
determine a route from the current location to a destination location based on at least the current location;
generate, based on the route, the GUI, wherein the GUI comprises:
a message bar configured to selectively display a textual description of at least one of a direction for the aircraft to follow, a warning of an upcoming condition, or an alert of a proximate situation,
a next segment identifier of a next segment of the route,
a dynamic distance indication representing a distance from the current location to a next direction transition on the route,
a direction arrow indicating a direction of the next direction transition, and
a current segment identifier of a current segment on which the aircraft is located, and
direct the display to display the GUI.

2. The system of claim 1, wherein the direction arrow comprises a countable number of tick marks on a vertical portion of the direction arrow corresponding to a countable number of available direction transitions which are present before the next direction transition and which are in a same direction as the direction of the next direction transition.

3. The system of claim 1, wherein the message bar is configured to display a textual description of the next direction transition on the route and the distance to the next direction transition.

4. The system of claim 1, wherein the message bar is configured to display a textual warning indicating that the aircraft is approaching a predetermined hot spot on the route, and wherein the direction arrow is configured to change in color when the textual warning is displayed.

5. The system of claim 1, wherein the message bar is configured to display a textual alert indicating that the aircraft is approaching a hold short position on the route.

6. The system of claim 1, wherein the GUI further comprises a top-down graphical representation of an airport layout corresponding to the route.

7. The system of claim 1, wherein the next segment identifier and the current segment identifier each comprise at least one of a taxiway identifier and a runway identifier.

8. The system of claim 1, wherein the display is integrated into an aircraft cockpit instrument panel.

9. The system of claim 1, wherein the GUI comprises a top-down view of the route, wherein the GUI comprises an adjacent arrangement of components comprising: the next segment identifier, the dynamic distance indication, the direction arrow, and the current segment identifier.

10. The system of claim 9, wherein each of the components are adjacent to at least another of the components.

11. A method for taxiway navigation of an aircraft, the method comprising:
receiving a current location of an aircraft;
determining a route from the current location to a destination location based on at least the current location;
generating, based on the route, a graphical user interface (GUI), wherein the GUI comprises:
a message bar configured to selectively display a textual description of at least one of a direction for the aircraft to follow, a warning of an upcoming condition, or an alert of a proximate situation,
a next segment identifier of a next segment of the route,
a dynamic distance indication representing a distance from the current location to a next direction transition on the route,
a direction arrow indicating a direction of the next direction transition, and
a current segment identifier of a current segment on which the aircraft is located, and
displaying the GUI on a display.

12. The method of claim 11, wherein the direction arrow comprises a countable number of tick marks on a vertical portion of the direction arrow corresponding to a countable number of available direction transitions which are present before the next direction transition and which are in a same direction as the direction of the next direction transition.

13. The method of claim 11, wherein the message bar is configured to display a textual description of the next direction transition on the route and the distance to the next direction transition.

14. The method of claim 11, wherein the message bar is configured to display a textual warning indicating that the aircraft is approaching a predetermined hot spot on the route, and wherein the direction arrow is configured to change in color when the textual warning is displayed.

15. The method of claim 11, wherein the message bar is configured to display a textual alert indicating that the aircraft is approaching a hold short position on the route.

16. The method of claim 11, wherein the GUI further comprises a top-down graphical representation of an airport layout corresponding to the route.

17. The method of claim 11, wherein the next segment identifier and the current segment identifier each comprise at least one of a taxiway identifier and a runway identifier.

18. The method of claim 11, wherein the display is integrated into an aircraft cockpit instrument panel.

19. The method of claim 11, wherein the GUI comprises a top-down view of the route, wherein the GUI comprises an adjacent arrangement of components comprising: the next segment identifier, the dynamic distance indication, the direction arrow, and the current segment identifier.

20. The method of claim 19, wherein each of the components are adjacent to at least another of the components.
